(19) United States
(12) Patent Application Publication
(10) Pub. No.: US 2017/0034085 A1
(43) Pub. Date: Feb. 2, 2017

(54) MESSAGING INTEGRATION IN CONNECTION WITH A TRANSPORTATION ARRANGEMENT SERVICE

(71) Applicant: Uber Technologies, Inc., San Francisco, CA (US)

(72) Inventors: Rahul Bijor, San Francisco, CA (US); Matthew Wyndowe, San Francisco, CA (US); Zoran Martinovic, San Francisco, CA (US); Dmitry Shevelenko, San Francisco, CA (US); Amritha Prasad, San Francisco, CA (US)

(21) Appl. No.: 15/221,368

(22) Filed: Jul. 27, 2016

Related U.S. Application Data
(60) Provisional application No. 62/199,223, filed on Jul. 30, 2015.

(51) Int. Cl. H04L 12/58; H04W 4/14

(52) U.S. Cl. CPC H04L 51/046; H04L 51/16; H04L 51/34; H04L 51/20; H04L 51/38; H04W 4/14

(57) ABSTRACT

A computing device can execute a messaging application corresponding to a messaging service and display a user interface comprising a messaging thread between a user of the mobile computing device and at least a second user, the messaging thread including textual content corresponding to a location. The computing device can then receive a user selection of the textual content, and generate a selectable transport request feature on the display to overlay at least a portion of the messaging thread. In various implementations, the selectable transport request feature can enable the user to request transport from a transportation arrangement service.

### CROSS REFERENCE TO RELATED APPLICATION

This application claims the benefit of priority to U.S. Provisional Application No. 62/199,223, entitled “MESSAGING INTEGRATION,” filed on Jul. 30, 2016; the aforementioned application being hereby incorporated by reference in its entirety.

### BACKGROUND

A network service can provide a platform to enable users to request and receive various services, such as location-based services, through use of computing devices. The network service can receive a request for a service from a user via the user's computing device and select a suitable service provider to provide the service for the user. Typically, an entity that implements the network service can develop and provide a client application that can be stored and run on the user's computing device to enable the user to communicate with the network service.

### BRIEF DESCRIPTION OF THE DRAWINGS

FIG. 1 illustrates an example system to communicate with multiple network services using a messaging application, under an embodiment.

FIGS. 2A and 2B illustrate example methods of communicating with multiple network services using a messaging application, according to an embodiment.

FIGS. 3A through 3D illustrate examples user interfaces that are displayed on computing devices, according to one or more embodiments.

FIGS. 4A through 4D illustrate other examples user interfaces that are displayed on computing devices, according an embodiment.

FIG. 5 illustrates an example method of a network service communicating with a computing device, in an embodiment.

FIG. 6 is a block diagram that illustrates a computer system upon which embodiments described herein may be implemented.

FIG. 7 is a block diagram that illustrates a mobile computing device upon which embodiments described herein may be implemented.

### DETAILED DESCRIPTION

Examples described herein provide a system to enable a messaging application, which communicates with a messaging network service, to provide content received from a non-messaging network service, such as a transport arrangement service. The system can implement processes to integrate data from the non-messaging network service into the messaging application, so as to provide the messaging application with additional functionality that was previously not available on the messaging application. Among other benefits and advantages, the examples as described enable a user of a computing device to request location-based or on-demand services by interacting with content concurrently provided by multiple network services in a single application.

According to an example, a computing device can run a messaging application that communicates with a messaging network service (e.g., a first network service) over one or more networks. A messaging application, as referred to herein, can correspond to an application that has the primary function of enabling a user to transmit and receive messages (e.g., text messages, instant messages, etc.) to and from other users, respectively. The computing device can display a user interface of the messaging application on a display, such as a messaging thread of a user of the computing device and at least a second user.

In some examples, the messaging thread can include one or more individual messages with textual content that is associated with a point of interest (POI) or an address. When the textual content is selected by the user, the messaging application can display a selectable feature that enables the user to request a location-based service, such as a transport service, in connection with the corresponding POI or the address. If the user selects the selectable feature, the messaging application can establish a connection with a transport arrangement service (e.g., a second network service that is independent of the messaging network service) and communicate with the transport arrangement service to receive data associated with the transport arrangement service. The messaging application can display content associated with the transport arrangement system on the user interface of the messaging application.

The messaging application can also display additional features to enable the user to request a transport service from the messaging application. For example, the messaging application can generate and transmit a request for the transport service to the transport arrangement service based on the parameters specified by the user. The messaging application can further integrate graphic content associated with the transport service in the existing messaging thread based on data received from the transport arrangement system. By providing data specific to the transport arrangement service in the messaging application and by enabling the user to request the transport service from the messaging application, the user can make a request for transport without having to launch or access a separate application, such as a designated client application of the transport arrangement service, on the computing device.

Still further, according to some examples, the user may use the messaging application to communicate with multiple other users in a group messaging thread. If the user requests to view information about or request a group transport service to transport multiple users that are participating in the group messaging thread, the messaging application can present a contact selection user interface to enable the user to select which of the multiple users to include in the group transport service. The contact selection user interface can include an indicator for each user in the group messaging thread and the user can toggle on or off individual users to include in the group transport service. The messaging application can then communicate with the transport arrangement service to receive data about the proposed group transport service based on the selected users and display the corresponding content in the user interface of the messaging application.

Among other technical effects, examples described herein provide a mechanism to enhance the functionality of a messaging application of a first network service by seamlessly integrating content associated with a second network service. In such examples, the user interface of the messaging application can present content pertaining to the second network service to enable a user to request location-based services using the messaging application itself. Still further, the enhanced functionality can enable data associated with other users (that the user is communicating with in a messaging thread) to be automatically incorporated with content associated with the second network service.

As used herein, a user device, a driver device, a computing device, and/or a mobile computing device refer to devices corresponding to desktop computers, cellular devices or smartphones, personal digital assistants (PDAs), laptop computers, tablet devices, etc., that can provide network connectivity and processing resources for communicating with one or more network services over one or more networks. Still further, examples described herein relate to a variety of services, such as a location-based or on-demand service. Such a service can correspond to a transport service, a food truck service, a delivery service, an entertainment service, a house cleaning service, etc., or generally, any on-demand service or any variable-priced service and/or post-paid transaction between a user and a service provider or provider of goods.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

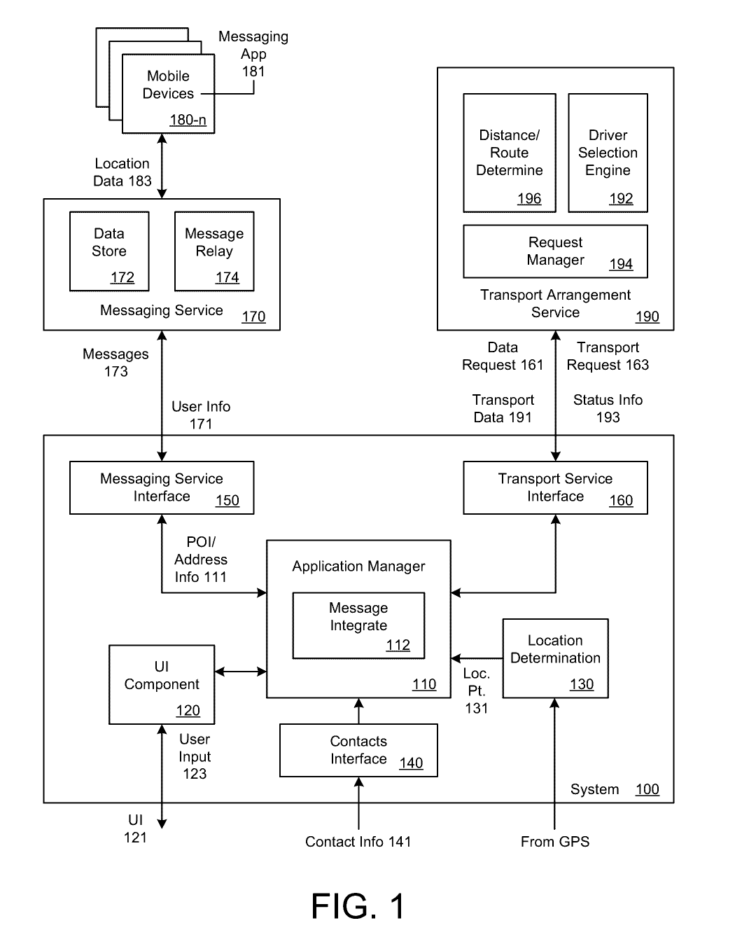

FIG. 1 illustrates an example system to communicate with multiple network services using a messaging application. According to an example, a system 100 can be implemented using memory and computing resources of a computing device, such as a mobile computing device operated by a user. The system 100 can correspond to or can be a part of a messaging application, such as a native messaging application of a mobile operating system of the computing device or a messaging application developed by a third-party entity (e.g., developed by a separate entity than the device or operating system manufacturer). In the example of FIG. 1, the system 100 includes an application manager 110, a user interface (UI) component 120, a location determination 130, a contacts interface 140, a messaging service interface 150, and a transport service interface 160. The components of the system 100 can combine to enable communication with multiple network services using a single messaging application and to integrate data and content from a non-messaging network service in the user interface of the messaging application. Logic can be implemented with various applications (e.g., software) and/or with hardware of a computer system that implements the system 100.

According to examples, a user can operate the system 100 to exchange communications (e.g., messages) with other users. When the user launches or opens the messaging application, the application manager 110 can communicate with the UI component 120 to cause a UI 121 to be displayed on the display of the computing device. The user can interact with the UI 121 by providing user input 123 via an input mechanism of the computing device, such as a touch-sensitive display or a keyboard. Based on the user input 123, the application manager 110 can cause the UI component 120 to display one of multiple messaging threads in the UI 121. As referred to herein, a messaging thread can correspond to one or more individual messages exchanged between the user and another user (or a group of users). Depending on the messaging application, one or more messaging protocols or channels can be used to transmit and receive individual messages (e.g., short message service, multimedia message service, instant message, e-mail, etc.).

In some examples, the application manager 110 can access a database that stores messaging threads of previously exchanged messages between the user and other users, and can cause the UI component 120 to display previously exchanged messages in individual messaging threads. The database can be stored locally in a memory resource of the computing device and/or can be stored in a data store 172 of the messaging service 170 that is accessible by the application manager 110 via the messaging service interface 150. When the user wants to message another user (or a group of users), the user can select a previously existing messaging thread with that user and send additional messages, or can create a new message (and subsequently, can create a new messaging thread) to send to that user. In one example, the application manager 110 can communicate with the contacts interface 140 to retrieve or receive contact information 141 (e.g., name, phone number, email address, user name, unique identifier, etc.) of other users from a contacts application or other contacts source stored on the user's computing device. The user can select, via user input 123 on the UI 121, one or more contact entries or names corresponding to other users to create and send a new message. As an addition or an alternative, the application manager 110 can retrieve or receive the contact information 141 from the messaging service 170 via the messaging service interface 150.

When a message is created and sent by the user, the application manager 110 can transmit the message 173 (along with the contact information of the receiving user) to the messaging service 170 over one or more networks via the messaging service interface 150 (e.g., using a cellular network, Wi-Fi or WLAN network, etc.). As described herein, a messaging service 170 can receive messages 173 from computing devices and can route the messages to the appropriate computing devices. The messaging service 170 can also store received messages 173 in the data store 172 and associate the messages 173 with the respective computing devices and/or user accounts. For example, a message 173 sent by the user of the system 100 can be provided to the messaging service 170, and the message relay 174 can route the message 173 to the appropriate mobile computing device 180 of another user. The mobile computing device 180 can run a similar or identical messaging application 181, which can display the message to the other user in a messaging thread.

The messaging service 170, such as described, can correspond to a network service that is implemented on network side resources, such as such as on one or more servers or computing systems. The messaging service 170 can also be implemented through other computer systems in alternative architectures (e.g., peer-to-peer networks, etc.). As an addition or an alternative, some or all of the components of the messaging service 170 can be implemented on client-side computing devices, such as through the messaging application on the computing device. In examples in which the messaging application corresponds to a native messaging application, the messaging service 170 can be a cellular network service provided by a cellular network provider (and/or a network service provided by the device manufacturer of the computing device). Alternatively, in examples in which the messaging application corresponds to a third-party messaging application (e.g., Facebook Messenger, Skype, Snapchat, KakaoTalk, etc.), the messaging service 170 can be implemented by the respective third-party entity. Such a messaging service 170 can also be a part of or be in association with a social networking service, in some examples.

In some examples, the messaging service 170 can also receive location data 183 from the messaging applications 181 operating on the mobile computing devices 180. The messaging application 181 can interface with a geo-aware resource of the mobile computing device 180, such as a global positioning system (GPS) receiver, to determine the location of the mobile computing device 180 (and subsequently, the user of that device). The location data 183 (e.g., a geo-coordinate, such as a latitude and longitude data point) can be determined by the messaging application 181 and can be provided to the messaging service 170 (e.g., periodically, based on a schedule, etc.). In one example, for individual messaging threads associated with the user of the system 100 and other users, the messaging service 170 can provide the location data 183 of the other users (e.g., along with user information, such as an image of the user), collectively referred to as user information 171, to the application manager 110.

Similarly, the location determination component 130 can receive, from the GPS receiver of the user's mobile computing device, a location data point 131 corresponding to the user's location. The location data point 131 can be provided to the application manager 110, which can associate the location data point 131 to the messages created and sent by the user on the messing application.

In some instances, a message that is sent or received as part of a messaging thread between the user and a second user may include textual content that corresponds to a location. The application manager 110 can determine whether textual content in a message corresponds to a point of interest (e.g., a name of a restaurant, a park, a landmark, etc.) or an address (e.g., 123 Main Street). According to one example, when each message is processed by the messaging service 170, the messaging service 170 can determine whether textual content corresponds to a POI or an address, and if so, can provide the POI or address information 111 to the application manager 110. In another example, the application manager 110 can communicate with other resources, such as a mapping service over one or more networks or another application stored on the computing device, to determine the POI or address information 111. If a message includes textual content that corresponds to a POI or an address, the application manager 110 can cause the textual content to be selectable by the user in the UI 121 so as to enable the user to perform other tasks or operations using the POI or the address.

The system 100 can also communicate with a second network service, such as the transport arrangement service 190, over one or more networks via the transport service interface 160. According to some examples, the transport service interface 160 can include or use an application programming interface (API), which is specific to the transport arrangement service 190, such as an externally facing API, to exchange data with the transport arrangement service 190. Such APIs can be programmed into or included in the code or instructions of the messaging application. The externally facing API can provide the system 100 with access to the transport arrangement service via secure access channels over the one or more networks through any number of methods, such as web-based forms, programmatic access via RESTful APIs, Simple Object Access Protocol (SOAP), remote procedure call (RPC), scripting access, etc. In some instances, the computing device can also communicate with the transport arrangement service 190 independent of the messaging application by using, for example, a designated service application that is configured to communicate with the transport arrangement service 190.

As described herein, the transport arrangement service 190 can provide a mechanism to enable users to request transport services and can arrange service providers (e.g., drivers) to provide those transport services based on user-specified parameters, such as pickup locations and/or destination locations. The transport arrangement service 190 can correspond to a network service that is implemented on network side resources, such as such as on one or more servers or computing systems, or implemented through other computer systems in alternative architectures. As an addition or an alternative, some or all of the components of the transport arrangement service 190 can be implemented on client-side computing devices, such as through the messaging application or the designated service application on the computing device. The transport arrangement service 190 can include, for example, a request manager component 194 to receive and process requests for transport services that are received from client devices, such as the computing device of the user, and a driver selection engine 192 to perform a driver selection process for selecting drivers to service those requests.

The transport arrangement service 190 can include one or more databases to store user profiles or accounts of those users that have registered or signed up for the transport arrangement service 190. In the examples described herein, the user of the system 100 can already have an existing account with the transport arrangement service 190. The user account can include or be associated with the name of the user, an identifier of the user, device information of the user's device, contact information (e.g., phone number, email address, etc.), personal information (e.g., home address, billing address), payment mechanism information (e.g., credit card or banking information, or online payment information, etc.), and historical information of previous transport services taken by the user.

When the user is operating the messaging application, the application manager 110 can enable content pertaining to the transport arrangement service 190 to be displayed in the UI 121 of the messaging application. For example, if a message in a messaging thread includes textual content associated with a POI or an address, the textual content can be made selectable by the application manager 110. If the user selects the textual content, or alternatively, selects a specified selectable icon or feature in the UI 121 of the messaging application, the UI component 120 can display a plurality of options that the user can perform in connection with that textual content. In one example, a panel can be displayed to at least partially overlay the messaging thread with multiple selectable features, such as (i) a first selectable feature that causes the computing device to launch or open a mapping application to show the POI or the address on a map, (ii) a second selectable feature that enables the user to copy the textual content (which the user can paste at a later time), and (iii) a third selectable feature to provide the user with an option to travel to the POI or the address. The third selectable feature can enable the user to view and/or request information from the transport arrangement service 190 in the messaging application without having to navigate the user to another application.

If the user selects the feature to request a transport service, the application manager 110 can communicate a data request 161 to the transport arrangement service 190 via the transport service interface 160. The data request 161 can correspond to a call for retrieving or receiving data associated with the transport arrangement system 190 (e.g., referred to as transport data 191). In one example, the data request 161 can include the location data point 131 of the current location of the computing device so that the transport data 191 can be based on the user's specific location. Such transport data 191 can include an available vehicle type(s) at the user's location, an estimated travel time or arrival time for a driver to pick up the user at the user's location, price information for the transport service, etc. The application manager 110 can use the received transport data 191 to generate and display content associated with the transport arrangement service 190 within the UI 121 of the messaging application.

For purpose of simplicity, the application manager 110 can communicate with the transport arrangement service 190 in response to the user selecting the feature, provided that the user has an account with the transport arrangement service 190. In one example, however, if the user of the system 100 does not have an account with the transport arrangement service 190, the transport arrangement service 190 can transmit data to the application manager 110, which can cause the messaging application to notify the user that he or she needs to sign up with an account. The messaging application can then display one or more UIs 121 to enable the user to create an account with the transport arrangement service 190. In some examples, the messaging application can populate one or more fields that are required for the user to create an account with the transport arrangement service 190, such as the name, contact information, and even a payment mechanism or profile. For example, the user may have a payment mechanism stored with the messaging service (or a social network service associated with the messaging service), such as a credit card or an online payment mechanism. The messaging application can populate the fields and the user can select a feature, e.g., “create account,” which causes the application manager 110 to transmit the user data to the transport arrangement service 190. Once the transport arrangement service 190 creates the user account, the transport arrangement service 190 can transmit transport data 191 to the application manager 110.

In addition, in some examples, the application manager 110 can access mapping data from a mapping application on the computing device and/or can receive, as part of the transport data 191 or independently of the transport data 191, the mapping data from the transport arrangement service 190. The application manager 110 can use mapping data of a region of the user's location to include a map as part of the content associated with the transport arrangement service 190. The map can include a start location, such as the user's current location, and a destination location, which corresponds to the POI or the address initially selected by the user. In one example, the distance/route determine 196 can provide a proposed route of travel from the start location to the destination location to be displayed in the map. Still further, in other examples, graphic indicators corresponding to the real-time or close to real-time locations of vehicles in the region can be displayed on the map. The data corresponding to the proposed route and the locations of the vehicles/drivers can be provided by the transport arrangement service 190 as part of the transport data 191.

The displayed content associated with the transport arrangement service 190 can include a selectable feature to enable the user make a request for a transport service. If the user makes the request, the application manager 110 can generate a transport request 163 and transmit the transport request 163 to the transport arrangement service 190. The transport request 163 can include an identifier associated with the user (e.g., associated with the user's profile or account with the transport arrangement service 190), a pickup location (corresponding to the current location data point 131) and/or a destination location, and a vehicle type. The request manager 194 can process the transport request 163 by creating a trip entry associated with the requested transport service, and the driver selection engine 192 can perform a driver selection process to identify a driver that can provide the transport service for the user. Once the transport service is arranged, the transport arrangement service 190 can provide information about the selected driver (and the transport service), referred to as status information 193, to the system 100.

A message integration component 112 of the application manager 110 can use the status information 193 and integrate content about the transport service as a graphic image or representation in the messaging thread. According to one example, the user can view detailed information about the transport service by selecting the graphic image or representation. In another example, the application manager 110 can automatically transmit an image corresponding to the detailed information about the transport service to the other user(s) of the messaging thread via the messaging service interface 150. In this example, the other user(s) can operate the messaging application 181 to view the detailed information by interacting with the messaging thread.

According to some examples, the user of the system 100 can interact with a messaging thread between the user and multiple other users (e.g., a second user and a third user). When a message from the second and third users is received by the application manager 110, the application manager 110 can also receive the respective user information 171 from the messaging service 170, such as a user ID, an image or photo of the user, and a location data point 183 of the user. As described herein, the application manager 110 can communicate with the UI component 120 to provide a selectable feature (e.g., selectable textual content of a POI or address, or a graphic icon) to enable the user of the system 100 to view content associated with the transport arrangement service 190. In one example, the application manager 110 can provide a selectable feature to enable the user to request a group transport service for multiple users of the messaging thread, such as a group transport service for the user, and the second user and/or third user, to a specified destination (e.g., a POI or address).

The UI component 120 can provide a contact selection user interface in the messaging application, which includes an indicator for each user of the messaging thread (e.g., one contact entry for each of the user, the second user, and the third user). The indicators can each be selectable (e.g., toggled on or off) via user input 123 to add or remove a respective user from the request for the group transport service. When the user selects the users for the group transport service, the application manager 110 can transmit a data request 161 to the transport arrangement service 190. In one example, the data request 161 can include (i) the user ID of the user of the system 100, (ii) a location data point 131 of the user, (iii) the specified destination, and/or (iv) the location data points 183 of the other users that have been selected (by the user) to share in the group transport service.

The transport arrangement service 190 can provide transport data 191 to the application manager 110 based on the information in the data request 161. According to one example, the distance/route determine 196 can use the locations of the user, the second user and/or the third user, and the destination to determine a proposed route of travel to transport each of the users in the group transport service to the destination. Depending on implementation, the distance/route determine 196 can determine the proposed route to minimize the amount of distance traveled by a single driver and/or to minimize the amount of time it would take to pick up each of the users and drop them off at the destination. The transport arrangement service 190 can provide information about the proposed route as part of the transport data 191 to the application manager 110. The application manager 110 can use the transport data 191 to integrate and display content associated with the transport arrangement service in the UI of the messaging application, including displaying, on a map, a graphic representation of the proposed route from a start location to the locations of the users sharing in the group transport service to the destination location. Still further, in one example, the application manager 110 can use the user information 171 of the second user and/or the third user to show the estimated location of the individual users (along with an image of the user(s)) on the graphic representation of the proposed route to show the order in which the users would be potentially picked up by a driver. The user can then request the group transport service by interacting with the integrated content on the UI of the messaging application.

When a driver is selected for the group transport service, the transport arrangement service 190 can monitor the status or progress of the driver and/or the group transport service and provide status information 193 to the user of the system 100. A driver can operate a driver device that can run a driver application that communicates with the transport arrangement service 190. The driver application can also determine the current location of the driver by receiving location data from the GPS receiver of the driver device and provide the location data (e.g., periodically) to the transport arrangement service 190. In one example, the transport arrangement service 190 can determine, from user input provided by the driver on the driver device, when the group transport service has been started (e.g., one of the users has been picked up). The transport arrangement service 190 can also determine when other users have been picked up based on (i) determining that the driver has been stationary at or near (within a proximate distance of) the individual locations of the other users for a predetermined duration of time, or (ii) receiving user input provided by the driver on the driver application indicating that the next user has been picked up, and so forth.

The transport arrangement service 190 can also process the payment for the fare for the group transport service. Once the group transport service is determined to be completed (e.g., in response to the driver providing input on the driver application), the transport arrangement service 190 can use a set of price parameters to determine the cost for the group transport service based on a duration of time and/or a distance traveled. According to examples, the user who initiated the group transport service can be the primary user and the transport arrangement service 190 can charge the payment mechanism associated with that user's account. In other examples, when a group transport service is requested using the messaging application, the transport arrangement service 190 can, by default, divide the cost for the group transport service evenly (or substantially evenly) between the users of the group transport service. Still further, in another example, when the user of the system 100 initially views the content associated with the transport arrangement service in the UI 121, before requesting the group transport service, the user can toggle on or off a selectable feature (e.g., a check box or a slider) to share the fare for the group transport service or not. Depending on the user's selection, the transport arrangement service 190 can either divide the cost for the group transport service or charge the payment mechanism of the user.

According to some examples, if a user in the group transport service does not have an account with the transport arrangement service 190 (and consequently, does not have a stored payment mechanism), the transport arrangement service 190 can use the contact information for that user and prompt the user to join the transport arrangement service 190. The prompt can be sent to that user via the messaging application (or another messaging application) and can include a link to download the designated client application or to open a web page for signing up with the transport arrangement service 190 in a web browser application.

As an addition or an alternative, the messaging service 170 and the transport arrangement service 190 can exchange data between each other using APIs or other secure communication mechanisms. The message service 170 can determine the location of the users and can periodically provide the locations to the transport arrangement service 190. The transport arrangement service 190 can compare the received location data to the location of the driver (and/or the route being traveled by the driver) to determine whether the other users have been picked up. For example, after the first user is picked up, the driver can travel to the second user's pickup location. If the second user has been picked up, the location of the second user from the messaging service 170 should be close to or within a specified distance of the driver location, e.g., such as during the time the vehicle travels to the location of the third user. The transport arrangement service 190 can provide status information 193 when the users are individually picked up to the other users of the group transport service.

Still further, in one example, the application manager 110 can determine, from the status information 193, when all users of the group transport service has been picked up and/or when the vehicle is close to the destination location. Alternatively, the application manager 110 can determine when the vehicle is close to the destination location based on the location of one or more of such users being within a proximity or predetermined distance of the destination location. The application manager 110 can communicate with the messaging service 170 or another network service, such as a social network service or a service that publishes crowd-sourced reviews of businesses and restaurants, to determine information about the POI or address corresponding to the destination. If the users are close to being dropped off or if the users are a predetermined distances or time of arrival away from the destination, the application manager 110 can provide, in the messaging thread, information about the POI or address corresponding to the destination (e.g., reviews, highlights of the venue or restaurant, coupons, etc.). In this manner, users can automatically view information about the POI in the messaging application (or as a push notification) before they leave the vehicle.

As an addition or an alternative, in another example, the messaging service 170 can determine other users (that are friends or associates of the user of the system 100) that have been to the POI or the address that the user or group of users are traveling to. For example, the messaging service 170 can be a part of a social networking service or can communicate with a social networking service, with which the user has an account. One or more of the user's friends may have previously indicated on his or her respective social networking profile that he or she had been to the POI or address. Before, during, or after the transport service is arranged for the user, the messaging service 170 can provide information about those friends that have been to the same POI or address, and can automatically prompt the user to reach out to them and/or can automatically create a message that the user can send to initiate conversations with them (e.g., “Hey, I'm going to Arlequin Wine Merchant, do you want to join?” or “Hi, I'm going to Arlequin Wine Merchant, can you tell me what I should order there?”).

### Methodology

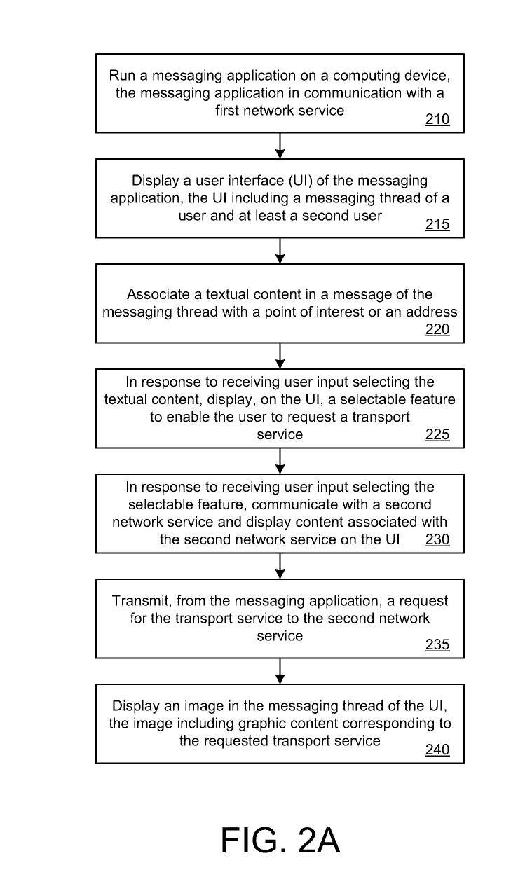

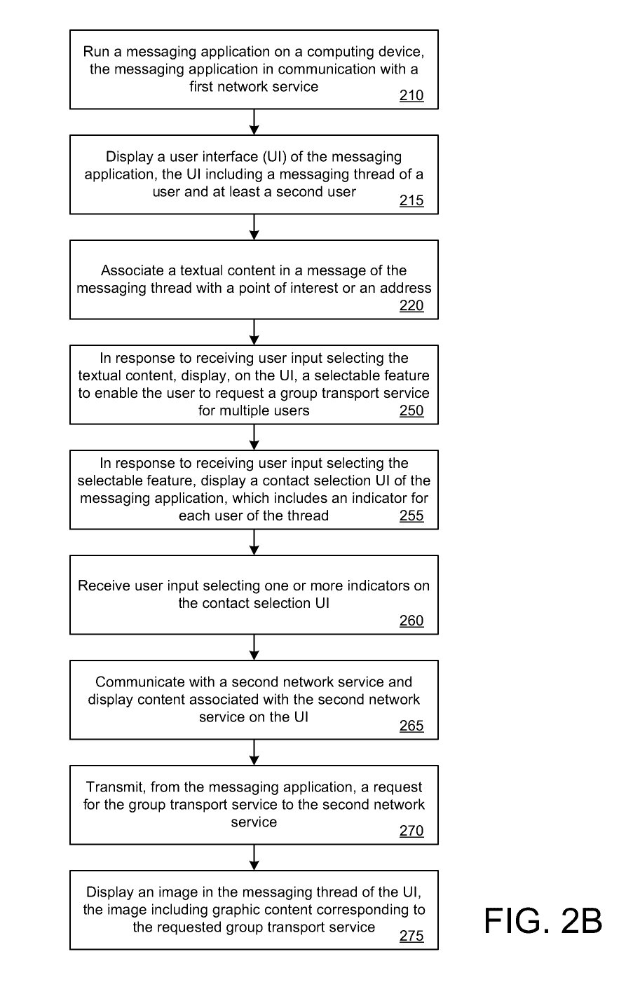

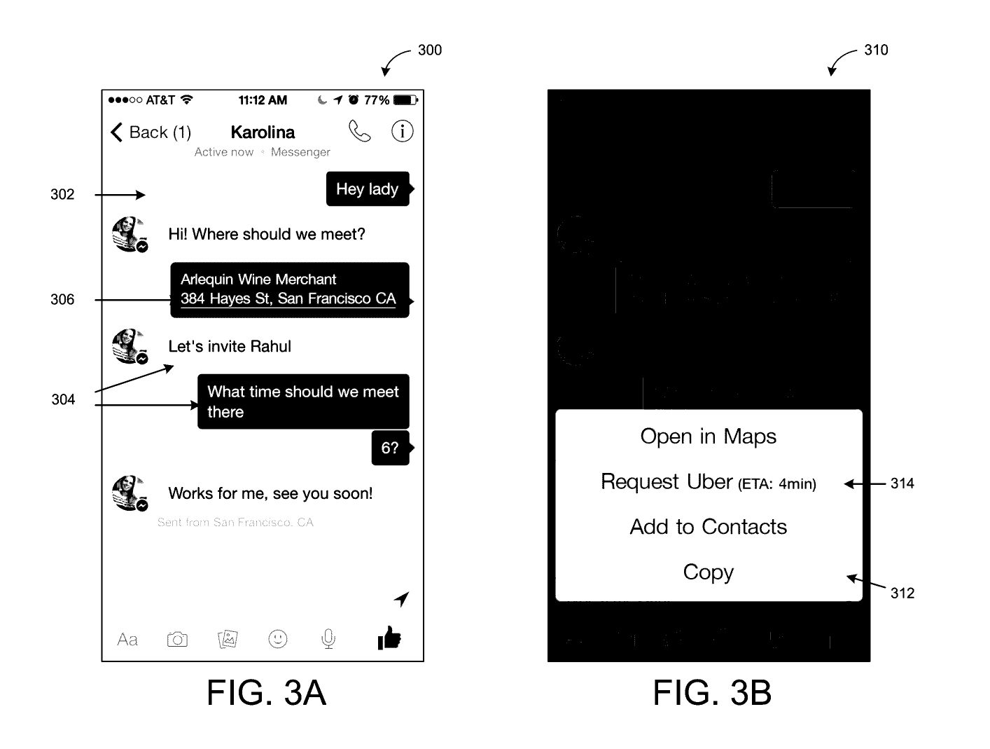

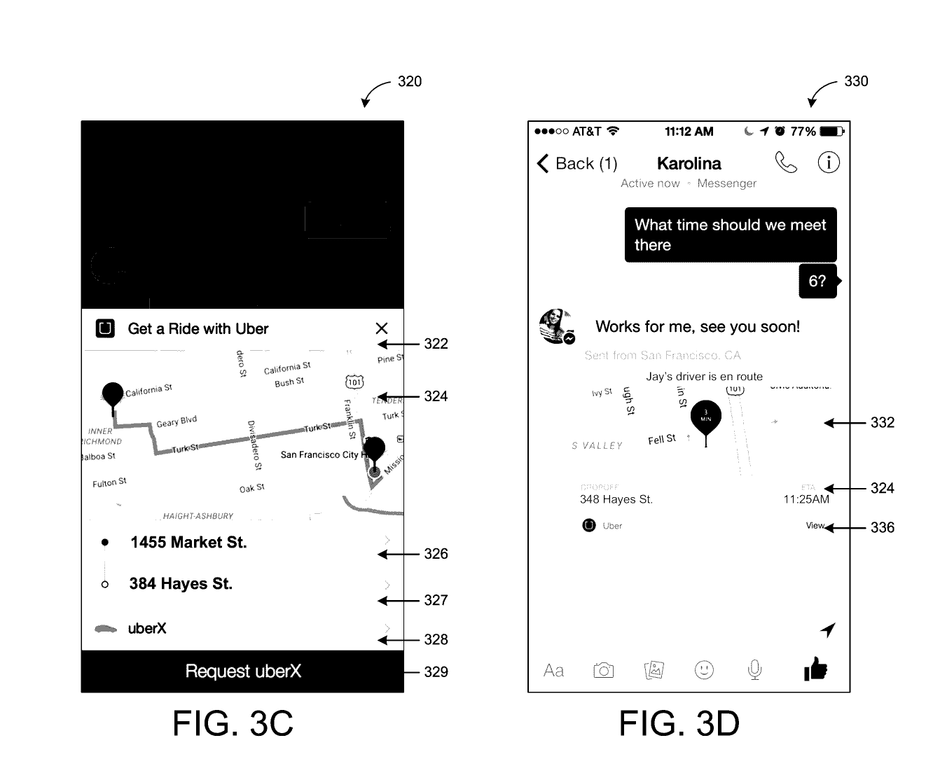

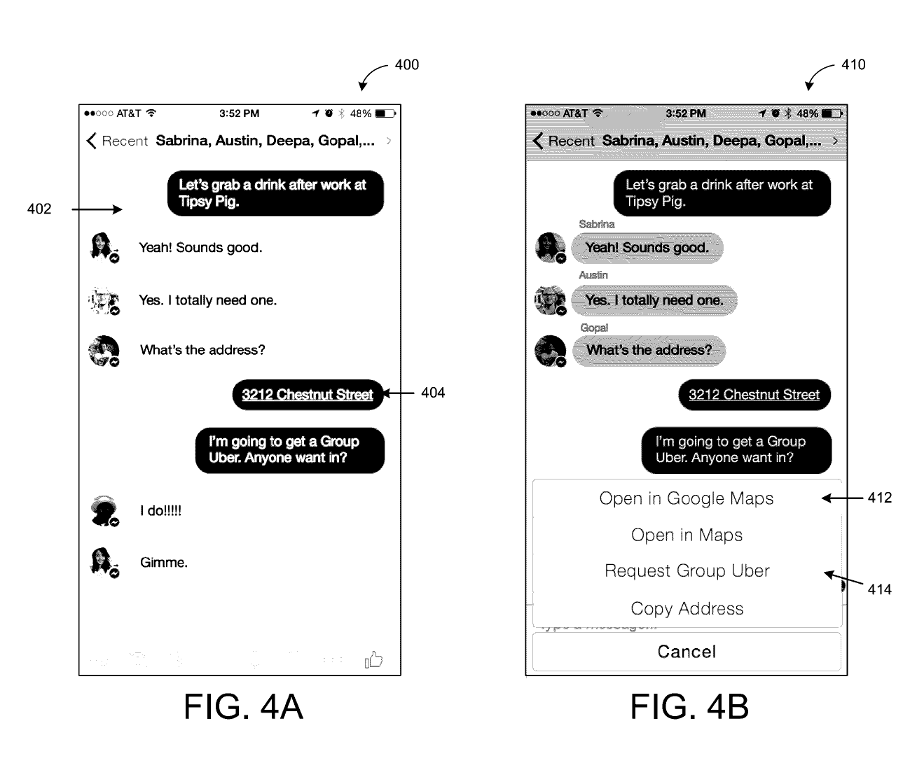

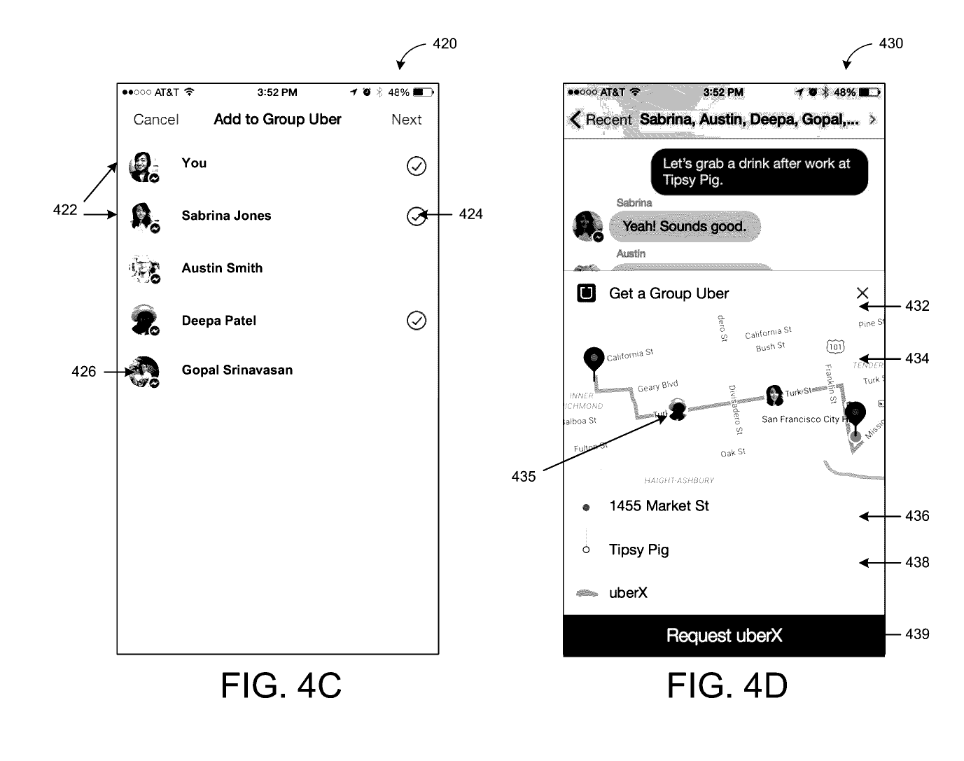

FIGS. 2A and 2B illustrate example methods of communicating with multiple network services using a messaging application, according to an embodiment. The methods such as described by examples of FIGS. 2A through 2B can be implemented using, for example, components described with the example of FIG. 1. FIGS. 2A and 2B are also described with FIGS. 3A through 4D for purposes of illustration.

Referring to FIG. 2A, a user of a mobile computing device (e.g., the first user) can operate a messaging application using memory and computing resources on the mobile computing device. The mobile computing device can launch and run the messaging application, which can be in communication with a first network service, such as a messaging service (210). The messaging application can present, on a display of the mobile computing device, a UI of the messaging application, which can include a messaging thread of the first user and at least a second user (215). The messaging thread can correspond to one or more messages that are exchanged between the first user and at least the second user. For example, referring to FIG. 3A, the UI 300 can include a messaging thread 302 between the first user and Karolina (the second user). The messaging thread 302 can include a plurality of messages 304. As illustrated herein, the user interfaces of FIGS. 3A through 4D can be displayed for the first user of the messaging application. However, similar user interfaces can be displayed on the devices of the other users by respective messaging applications.

In one example, one or more of the messages of the messaging thread can include textual content that corresponds to a POI or an address. The messaging application can associate the textual content with a POI or an address by (i) receiving information from the messaging network service that the textual content is a POI or an address, or (ii) accessing a mapping network service (or a mapping application stored on the mobile computing device) to determine that the textual content is a POI or an address (220). The messaging application can make the textual content selectable, such as by making the textual content a link, as illustrated in the example of FIG. 3A (e.g., the textual content 306, “384 Hayes Street, San Francisco, Calif.,” is shown as a link within a message 304).

When the first user selects the textual content (or alternatively, another designated graphic feature in the UI, such as a logo or an icon), the messaging application can display, on the UI, a selectable feature to enable the first user to request a transport service (225). For example, as illustrated in FIGS. 3A and 3B, if the first user selects the textual content 306, the messaging application can display the UI 310, which includes a panel 312 with a plurality of selectable features that correspond to different options. In FIG. 3B, the first user can view the address in a map application, add the address to an entry in the first user's contacts or phone book, copy the textual content or address, or select the feature 314 to request a transport service.

If the first user provides input to select the feature 314, e.g., to request a transport service, the messaging application can (i) communicate with a second network service, such as a transport arrangement service, over one or more networks to receive data associated with the transport arrangement service, and (ii) use the received data to display interactive content associated with the transport arrangement service in the UI of the messaging application (230). The displayed interactive content can be integrated with the UI of the messaging application, such as illustrated in FIG. 3C. In some examples, the messaging application can make a data call to the second network service and provide user data to the second network service, such that the messaging application can receive data that is specific to the first user.

For example, as illustrated in FIG. 3C, in response to the first user selecting the feature 314, the messaging application can receive data about the transport arrangement service, and can display content 322 in the UI 320 of the messaging application. The interactive content 322 can include a map 324 with a start location indicator (e.g., the first user's current location as determined by the messaging application or the most recent location determined by the messaging application), which corresponds to the start location 326, and a destination location indicator corresponding to the selected textual content in the messaging thread 302 (384 Hayes Street), which corresponds to the destination location 327. The map 324 can also include a proposed route from the start location to the destination location. The content 322 can also include a selection feature 328 for viewing and choosing a vehicle type. The messaging application can also enable the first user to make a request for the transport service from the messaging application. Once the first user verifies the information, the first user can select the feature 329 to request the transport service. In some examples, although not illustrated in FIG. 3C, the content 322 can also include other information about the transport arrangement service or the proposed transport service, such as the estimated time of arrival to pick up or the estimated travel time from the pick up location to the destination location.

If the first user requests a transport service, the messaging application can transmit a request for the transport service to the transport arrangement service (235). The request can be generated by the messaging application, and can include (i) a user ID, (ii) a pickup location, (iii) a destination location, and/or (iv) a vehicle type. Once the request is transmitted to and/or processed by transport arrangement service, the messaging application can receive status information about the transport service (e.g., a driver is being selected, the driver has been selected, the driver is approaching now, etc.) from the transport arrangement service. The messaging application can display an image in the messaging thread of the UI using the status data received from the transport arrangement service (240). The image can include graphic content and/or textual content corresponding to the requested service, such as illustrated in the example of FIG. 3D. The UI 330 illustrates the messaging thread (the messaging thread 302 as shown in FIG. 3A) with a new image 332 being integrated with the messaging thread as a separate message. The image 332 can include a destination location and an estimated time of arrival 324. The image 332 can be selectable to expand and display additional content, such as by selecting the view feature 336 or by selecting the map content in the image 332.

According to some examples, the image 332 can be automatically generated by the messaging application when the request for transport service is made and/or when the messaging application receives the status information from the transport arrangement service notifying the messaging application that a driver has been selected for the first user. Still further, the messaging application can send data corresponding to the image 332 to the other user device(s), e.g., Karolina's device, via the messaging network service, such as, for example, as an MMS message. Still further, in some examples, the image 332 can be linked to a specified web page, such as one provided by the transport arrangement service, so that an individual user of the messaging thread can view dynamic content about the transport service in a web browser application. For example, the web page can dynamically show the current or real-time (or close to real-time) location of the driver on a map content as well as an updated ETA.

Because users can communicate addresses and locations with each other using messages and those addresses correspond to locations that the users may be planning on meeting at, the messaging application can provide an efficient mechanism to enable those users to quickly request transport services to those locations. Information about the requested transport services can also be integrated within a messaging thread so that users of the messaging thread can view such information on their respective devices seamlessly while communicating together within the messaging application. In this manner, the user does not have to switch back and forth from the messaging application to a separate client application (that is designated to communicate with the second network service) to view and make requests for transport services.

As an addition or an alternative, in one example, the messaging application can provide an option, via a selectable feature, to enable the first user to request a transport service for the other user of a messaging thread. Referring to FIG. 3B for example, the UI 310 can include a selectable feature in the panel 312 to request a transport service for another user, e.g., “Request Uber for Karolina.” In such an example, if the first user selects such feature, the location data of the other user can be provided to the transport arrangement service as part of the request for data. The transport arrangement service can provide data, which the messaging application can use to integrate information associated with the transport service for the other user in the UI of the messaging application. Referring to FIG. 3C, the information provided in the content 322 can instead be predetermined or pre-populated to include a starting location corresponding to the location of the other user (as opposed to 1455 Market Street of the first user) and a destination location corresponding to 384 Hayes Street. Once the transport service is requested by the first user for the other user and/or once a driver is selected for the transport service, the messaging application can receive status information about the transport service and integrate information about that transport service in the existing messaging thread between the first user and the other user.

FIG. 2B illustrates another example method implemented on a user's computing device. Steps 210-220 of FIG. 2B are similar or identical to the steps as described in the example of FIG. 2A. Referring to step 250, in response to receiving user input selecting the textual content, the messaging application can display, on the UI, a selectable feature to enable the user to request a group transport service for multiple users (250). A group transport service can correspond to a transport service in which multiple users are picked up by a single driver as part of one transport service requested by the user.

For purposes of illustration, FIG. 4A depicts a UI 400 of a messaging application that includes a messaging thread 402 between the user and four other users (Sabrina, Austin, Gopal, Deepa). One of the messages 404 includes a textual content that is associated with a POI or an address (e.g., 3212 Chestnut Street) and that is made selectable for the user. When the user selects the textual content, the messaging application can display a selectable feature to enable the user to request a group transport service, such as illustrated in FIG. 4B. The UI 410 can include a panel 412 that includes multiple options, including the feature 414 for requesting a group transport service. In response to receiving user input selecting the feature 414, the messaging application can display a contact selection UI, such as illustrated in FIG. 4C (255). The contact selection UI 420 can include a plurality of contact entries 422 for each of the users participating in the messaging thread. Each contact entry 422 can have an indicator 424 that is selectable to toggle on or off. Based on which indicators for which users are selected “on,” the respective users can be included in a group transport service. Each contact entry 422 can also include a graphic image 426 corresponding to the user, which can be received or retrieved by the messaging application from the messaging network service.

The messaging application can receive user input to select one or more indicators on the contact selection UI (260). In the example of FIG. 4C, three users are selected by the user to participate in the group transport service, e.g., the user (You), Sabrina, and Deepa. When the user wishes to view information about the transport service or request the transport service, the user can select the “Next” feature. The messaging application can communicate with the second network service, e.g., the transport arrangement service via using APIs, to receive data associated with the group transport service and to display content using the received data (265). The displayed content can be provided in the UI of the messaging application, such as illustrated in FIG. 4D.

According to some examples, the received data associated with the transport arrangement service can be based on user location information that is transmitted to the transport arrangement service. For example, in FIG. 4D, the UI 430 can include content 432 corresponding to the proposed group transport service that can be requested by the user. The content 432 can be specified for the users in the messaging thread and can include a map 434 that displays a proposed route 435 from the start location (e.g., 1455 Market Street, corresponding to the user's location), to the locations of the other users, Sabrina and Deepa, to the destination location. The proposed route 435 can be based on the user locations provided to the transport arrangement service from the messaging application (or alternatively, provided from the messaging service). The proposed route 435 can be determined by the transport arrangement service to minimize the distance a driver would have to travel and/or to minimize the total time spent for the group transport service (e.g., using a routing engine). The content 432 can also include the start location 436, the destination location 438, and a feature 439 to enable the user to request the group transport service.

In one example, the messaging application can also integrate user data from the messaging service into portions of the content associated with the transport arrangement service. For example, in one instance, the messaging application can provide images of the users that are in the group transport service on the proposed route 435 in the map content 434, such as shown in FIG. 4D. The images can be included along the route based on the location of the respective users.

Still further, as an addition or an alternative, depending on the number of users that are selected by the user for the group transport service, the transport arrangement service can automatically determine the vehicle type or size for the group transport service. According to an example, if the number of users selected exceeds a threshold number (e.g., four), the transport arrangement service can automatically select a particular vehicle type (e.g., SUV type) that can provide transport for more than the threshold number (e.g., transports six users). If the number of users selected exceeds a second threshold number (e.g., seven) and/or if no vehicle types are available to transport a selected number of users, the transport arrangement service can notify the user that multiple vehicles will be requested and provide multiple proposed routes to pick up and drop off the users. The vehicle type information can be displayed in the content associated with the second network, such as the content 432 of FIG. 4D.

Referring back to FIG. 2B, the user can make a request for the group transport service by interacting with the displayed content on the UI of the messaging application. The messaging application can transmit a request for the group transport service to the transport arrangement service (270) and can display an image in the messaging thread of the UI, such as described with FIG. 2A (275).

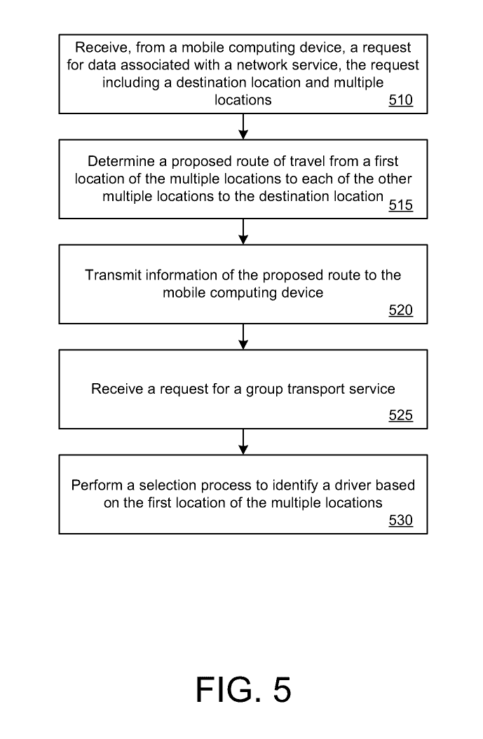

FIG. 5 illustrates an example method of a network service communicating with a computing device, according to an embodiment. The method such as described by the example of FIG. 5 can be implemented using, for example, components of the transport arrangement service described in the example of FIG. 1.

The transport arrangement service can receive, from a mobile computing device, a request for data associated with the transport arrangement service (510). The request for data can be made by a messaging application that is stored and operated on the mobile computing device. In one example, the request for data can include at least a destination location (e.g., a location data point, an address, etc.) and multiple locations, such as a location of a first user and a location of a second user.

The transport arrangement service can determine a proposed route of travel from a first location of the multiple locations (e.g., either the first user's location or the second user's location) to each of the other multiple locations and then to the destination location (515). The first location can correspond to the start location or the first location a driver would travel to in order to initiate the transport service. According to an example, because the request for data is received with a single destination location and multiple other locations, the transport arrangement service can determine that multiple users are to be picked up and that the group transport service is to terminate at the destination location. Based on this information, the transport arrangement service can use a routing engine and/or mapping data to determine the proposed route to minimize the amount of distance traveled by a driver and/or to minimize the time of travel for the group transport service. Alternatively, in one example, the user of the mobile computing device (that is interacting with the messaging application) can be automatically designated to be picked up first, and then the rest of the users can be picked up to optimize for distance and/or time.

The transport arrangement service can transmit the information of the proposed route to the mobile computing device (along with other information, in some examples) (520). The messaging application running on the mobile computing device can use this information to integrate and display content about the transport service in the UI of the messaging application. The content can also enable the user of the mobile computing device to make a request for the group transport service. If the user makes a request, the transport arrangement service can receive the request for the group transport service (525), and can subsequently process the request, including performing a selection process to select a driver to provide the group transport service based on the first identified location of the multiple locations (530). The transport arrangement service can also provide status information about the group transport service to the messaging application and can monitor the progress of the selected driver and/or the group transport service.

### Hardware Diagrams

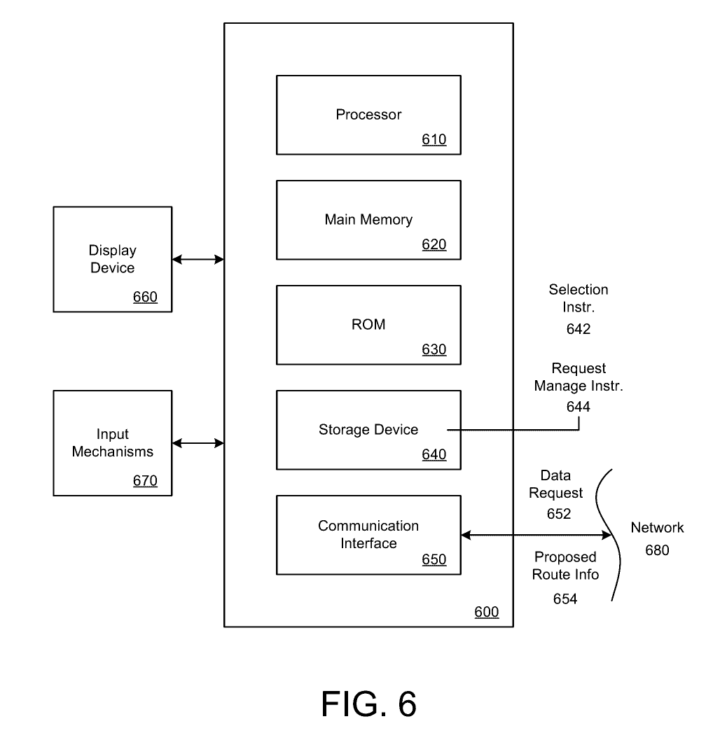

FIG. 6 is a block diagram that illustrates a computer system upon which embodiments described herein may be implemented. For example, in the context of FIG. 1, the transport arrangement service 190 may be implemented using a computer system such as described by FIG. 6. The transport arrangement service 190 may also be implemented using a combination of multiple computer systems as described by FIG. 6.

In one implementation, a computer system 600 includes processing resources 610, a main memory 620, a read only memory (ROM) 630, a storage device 640, and a communication interface 650. The computer system 600 includes at least one processor 610 for processing information and the main memory 620, such as a random access memory (RAM) or other dynamic storage device, for storing information and instructions to be executed by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions, including selection instructions 642 and request manage instructions 644, and other instructions, such as distance/route determine instructions. The storage device 640 can also store a plurality of databases and entries, such as described in FIG. 1.

For example, the processor 610 can execute the request manage instructions 644 to implement logic for receiving requests for data and/or requests for transport services from computing devices, such as described in FIGS. 1 through 5. The processor 510 can execute the selection instructions 642 to implement logic for performing a driver selection process for individual transport services, such as described in FIGS. 1 through 5.

The communication interface 650 can enable the computer system 600 to communicate with one or more networks 680 (e.g., cellular network) through use of the network link (wireless or wireline). Using the network link, the computer system 600 can communicate with one or more other computing devices, such as mobile computing devices operated by users, and/or one or more other servers or datacenters (e.g., the messaging service in some examples). In some variations, the computer system 600 can receive a data request 652 from a messaging application on a user's mobile computing device via the network link. The computer system 600 can determine, based on data from the request 652, information pertaining to the transport arrangement service that is to be transmitted for integration with the messaging application. The computer system 600 can provide data associated with the transport arrangement service to the mobile computing device, including information about a proposed route 654 based on information from the data request 652, such as described in FIGS. 1 through 5.

The computer system 600 can also include a display device 660, such as a cathode ray tube (CRT), an LCD monitor, or a television set, for example, for displaying graphics and information to a user. One or more input mechanisms 670, such as a keyboard that includes alphanumeric keys and other keys, can be coupled to the computer system 600 for communicating information and command selections to the processor 610. Other non-limiting, illustrative examples of input mechanisms 670 include a mouse, a trackball, touch-sensitive screen, or cursor direction keys for communicating direction information and command selections to the processor 610 and for controlling cursor movement on the display 660.

Examples described herein are related to the use of the computer system 600 for implementing the techniques described herein. According to one embodiment, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

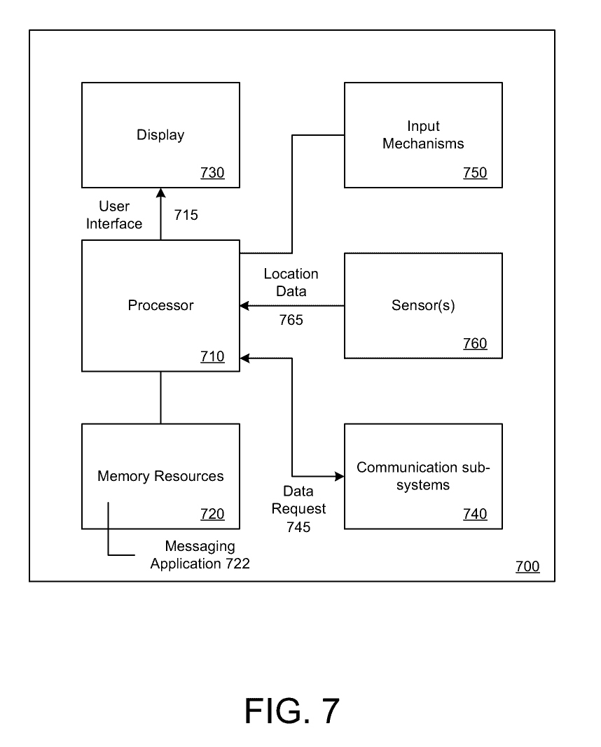

FIG. 7 is a block diagram that illustrates a mobile computing device upon which embodiments described herein may be implemented. In one embodiment, a computing device 700 may correspond to a mobile computing device, such as a cellular device that is capable of telephony, messaging, and data services. The computing device 700 can correspond to a device that implements, for example, the system 100 as described in FIG. 1. Examples of such devices include smartphones, handsets or tablet devices for cellular carriers. The computing device 700 includes a processor 710, memory resources 720, a display device 730 (e.g., such as a touch-sensitive display device), one or more communication sub-systems 740 (including wireless communication sub-systems), input mechanisms 750 (e.g., an input mechanism can include or be part of the touch-sensitive display device), one or more sensors 760, including a location detection mechanisms (e.g., GPS receiver), and a camera (not shown in FIG. 7). In one example, at least one of the communication sub-systems 740 sends and receives cellular data over data channels and voice channels.

The processor 710 can provide a variety of content to the display 730 by executing instructions and/or applications that are stored in the memory resources 720. For example, the processor 710 is configured with software and/or other logic to perform one or more processes, steps, and other functions described with implementations, such as described by FIGS. 1 through 6, and elsewhere in the application. In one example, the processor 710 can execute instructions and data stored in the memory resources 720 in order to operate a messaging application 722, as described in FIGS. 1 through 6. The processor 710 can cause one or more user interfaces 715 to be displayed on the display 730, such as one or more user interfaces described in FIGS. 1 through 4D. Input can be provided on the messaging application through a combination of the input mechanisms 750 and the display 730, for example, such as through use of a touch-sensitive display device.

In some examples, the messaging application 722 can run on the computing device 700, which can communicate with both the messaging network service and the transport arrangement service via the communication sub-systems 740. The messaging application 722 can also communicate with the sensor(s) 760 to determine location data 765 corresponding to the current location of the computing device 700. A user can operate the messaging application 722 using the user interface 715 to exchange messages with another user in a messaging thread. Based on the input provided by the user, the computing device 700 can generate and transmit a data request 745, which can include the location data 765, to the transport arrangement service via the communication sub-systems 740. The data request 745 can be a call made to the transport arrangement service to receive information about a transport service that can be integrated within the UI 715 of the messaging application. While FIG. 7 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A mobile computing device comprising:
a display;
one or more processors; and
one or more memory resources storing instructions that, when executed by the one or more processors, cause the mobile computing device to:
in response to a user selection input on the display, execute a messaging application corresponding to a messaging service;
upon execution of the messaging application, display a user interface comprising a messaging thread between a user of the mobile computing device and at least a second user, the messaging thread including textual content corresponding to a location;
receive a user selection of the textual content; and
in response to the user selection of the textual content, generate a selectable transport request feature on the display to overlay at least a portion of the messaging thread, the selectable transport request feature to enable the user to request a transportation arrangement service.

2. The mobile computing device of claim 1, wherein the executed instructions cause the mobile computing device to generate the selectable transport request feature by (i) transmitting a current location of the user to the transportation arrangement service over a network, (ii) receiving estimated time of arrival (ETA) data corresponding to a driver in relation to the current location, and (iii) displaying the selectable transport request feature to include the ETA data.

3. The mobile computing device of claim 1, wherein the executed instructions further cause the mobile computing device to:
receive a user selection of the selectable transport request feature;
in response to the user selection of the selectable transport request feature, generate interactive content on the display to enable the user to request transportation, via a network link between the messaging application and the transportation arrangement service, from a current location of the user to a destination location.

4. The mobile computing device of claim 3, wherein the executed instructions cause the mobile computing device to generate the interactive content to overlay at least the portion of the messaging thread.

5. The mobile computing device of claim 3, wherein the location corresponding to the textual content comprises a point of interest or an address, and wherein the executed instructions cause the one or more processors to automatically input the point of interest or address as the destination location for the transportation arrangement service.

6. The mobile computing device of claim 3, wherein the executed instructions cause the mobile computing device to establish the network link between the messaging application and the transportation arrangement service via an application programming interface associated with the transportation arrangement service.

7. The mobile computing device of claim 3, wherein the executed instructions cause the mobile computing device to generate the interactive content to enable the user to select from a plurality of vehicle types.

8. The mobile computing device of claim 3, wherein the executed instructions cause the mobile computing device to generate the interactive content to enable the user to request group transportation to pick up the user at the current location and at least the second user at one or more additional locations.

9. The mobile computing device of claim 8, wherein the executed instructions further cause the mobile computing device to:
determine the one or more additional locations corresponding to at least the second user;
transmit location data corresponding to the one or more additional locations to the transportation arrangement service to enable the transportation arrangement service to determine an optimal route for a selected driver; and
based on the user requesting the group transportation, receive and display map data from the transportation arrangement service, the map data indicating (i) the optimal route in which the selected driver will pick up the user and at least the second user to transport to the destination location, and (ii) location points along the optimal route in which the selected driver will pick up the user and at least the second user.

10. The mobile computing device of claim 9, wherein the executed instructions cause the mobile computing device to display the location points on the optimal route to include respective images of the user and at least the second user of the messaging thread.

11. The mobile computing device of claim 10, wherein at least the second user comprises a plurality of users on the messaging thread.

12. A computer-implemented method of providing transportation services through messaging integration, the method being performed by one or more processors of a mobile computing device and comprising:
in response to a user selection input on a display of the mobile computing device, executing a messaging application corresponding to a messaging service;
upon execution of the messaging application, displaying a user interface comprising a messaging thread between a user of the mobile computing device and at least a second user, the messaging thread including textual content corresponding to a location;
receiving a user selection of the textual content; and
in response to the user selection of the textual content, generating a selectable transport request feature on the display to overlay at least a portion of the messaging thread, the selectable transport request feature to enable the user to request a transportation arrangement service.

13. The method of claim 12, further comprising:
receiving a user selection of the selectable transport request feature;
in response to the user selection of the selectable transport request feature, generating interactive content on the display to enable the user to request transportation, via a network link between the messaging application and the transportation arrangement service, from a current location of the user to a destination location.

14. The method of claim 13, wherein the mobile computing device establishes the network link between the messaging application and the transportation arrangement service via an application programming interface associated with the transportation arrangement service.

15. The method of claim 13, wherein the location corresponding to the textual content comprises a point of interest or an address, and wherein the mobile computing device automatically inputs the point of interest or address as the destination location for the transportation arrangement service.

16. The method of claim 13, wherein the mobile computing device generates the interactive content to enable the user to request group transportation to pick up the user at the current location and at least the second user at one or more additional locations.

17. The method of claim 16, further comprising:
determining the one or more additional locations corresponding to at least the second user;
transmitting location data corresponding to the one or more additional locations to the transportation arrangement service to enable the transportation arrangement service to determine an optimal route for a selected driver; and
based on the user requesting the group transportation, receiving and displaying map data from the transportation arrangement service, the map data indicating (i) the optimal route in which the selected driver will pick up the user and at least the second user to transport to the destination location, and (ii) location points along the optimal route in which the selected driver will pick up the user and at least the second user.

18. A transport arrangement system comprising:
one or more processors; and
one or more memory resources storing instructions that, when executed by the one or more processors, cause the transport arrangement system to:
receive, from a mobile computing device over one or more networks, a data request associated with a transportation arrangement service, wherein the data request includes a destination location and multiple pick-up locations;
in response to receiving the data request, determine an optimal route between the multiple pick-up locations to the destination location;
transmit, over the one or more networks, map data corresponding to the optimal route to the mobile computing device;
receive, from the mobile computing device, a group transportation request to pick up a user at each of the multiple pick-up locations for transport to the destination location;
select a driver to service the group transport request based on the optimal route; and
provide status information, corresponding to the selected driver servicing the group transport request, to the mobile computing device.

19. The transport arrangement system of claim 18, wherein the executed instructions cause the transport arrangement system to receive the data request from a messaging application executing on the mobile computing device.

20. The transport arrangement system of claim 19, wherein each user corresponding to the multiple pick-up locations is included in a messaging thread of the messaging application, and wherein the executed instructions further cause the transport arrangement system to:
receive, from the mobile computing device, location data indicating current locations of each user included in the messaging thread to determine the multiple pick-up locations and the optimal route.
